(19) United States
(12) Patent Application Publication
(10) Pub. No.: US 2008/0217149 A1
(43) Pub. Date: Sep. 11, 2008

(54) INTEGRATED ARRANGEMENT AND METHOD FOR PRODUCTION

(76) Inventors: Ulrich Schmid, Saarbruecken-Dudweiler (DE); Alida Wuertz, Marbach (DE); Volker Ziegler, Neubiberg (DE)

Correspondence Address: Muncy, Geissler, Olds & Lowe, PLLC, P.O. BOX 1364, FAIRFAX, VA, 22038-1364, US

(21) Appl. No.: 11/964,687

(22) Filed: Dec. 26, 2007

Related U.S. Application Data
(60) Provisional application No. 60/877,405, filed on Dec. 28, 2006.

(30) Foreign Application Priority Data
Dec. 23, 2006 (DE) DE 102006061386

(51) Int. Cl. H01H 57/00

(52) U.S. Cl. 200/181

(57) ABSTRACT

An integrated arrangement with a circuit and a MEMS switch element is provided, in which the circuit has a plurality of semiconductor components that are connected to form the circuit by metallic traces in several metallization levels located one over the other, in which the metallization levels are located between the MEMS switch element and the semiconductor components, so that the MEMS switch element is located over the topmost metallization level, in which the MEMS switch element is designed to be movable, the MEMS switch element is positioned with respect to a dielectric, so that the movable MEMS switch element and the dielectric produce a variable impedance (for a high-frequency signal), and in which a drive electrode, which is positioned with respect to the MEMS switch element and is for producing an electrostatic force to move the MEMS switch element, is constructed in the topmost metallization level.

This nonprovisional application claims priority to German Patent Application No. DE 102006061386, which was filed in Germany on Dec. 23, 2006, and to U.S. Provisional Application No. 60/877,405, which was filed on Dec. 28, 2006, and which are both herein incorporated by reference.

### BACKGROUND OF THE INVENTION

1. Field of the Invention

The present invention relates to an integrated arrangement and a method for production.

2. Description of the Background Art

From “Laminated High-Aspect-Ratio Microstructures in a Conventional CMOS Process,” by G. K. Fedder et al., in IEEE Micro Electro Mechanical Systems Workshop, p. 13, (San Diego, Calif.) Feb. 11-15, 1996, is known a method for producing a microstructure (MEMS—Micro-Electro-Mechanical System). Here, microstructures are integrated together with CMOS structures of a standard CMOS process. The microstructure is produced within the CMOS process through a combination of aluminum layers, silicon dioxide layers and silicon nitride layers. The silicon substrate, which serves as a sacrificial material, is etched in the area of the microstructure, first anisotropically and then isotropically, so that the microstructure is undercut. The metal layers and the dielectric layers that are normally used for electrical connections for the CMOS structures serve as masks for structuring the microstructure. A similar production process is disclosed in U.S. Pat. No. 5,717,631.

An improvement of this CMOS-process-compatible production of a microstructure is disclosed in “Post-CMOS Processing for High-Aspect-Ratio Integrated Silicon Microstructures,” by H. Xie et al., IEEE/ASME Journal of Microelectromechanical Systems, Vol. 11, Issue 2, pp. 93-101, April 2002, wherein the silicon substrate is thinned locally from the back of the wafer by anisotropic etching. The microstructure is subsequently exposed by anisotropic etching from the front of the wafer.

Known from US 2002/0127822 A1 and U.S. Pat. No. 6,528,887 B2 are microstructures on an SOI (Silicon On Insulator) substrate. The previously buried insulating layer of the SOI structure serves as a sacrificial layer and is removed by etching in order to expose the microstructure. In addition, measures are described that are intended to prevent undesired adhesion of the microstructure to the surface of the substrate. In DE 100 17 422 A1 as well, a buried oxide layer serves as sacrificial oxide that is etched to expose the microstructure made of polycrystalline silicon. The microstructure of polycrystalline silicon is structured through trenches etched in the polycrystalline silicon.

U.S. Pat. No. 5,072,288 describes the formation of three-dimensional tweezers which are movable in three dimensions. The arms of the tweezers, which are 200 μm long, are made of tungsten and are moved by electrostatic fields.

In U.S. Pat. No. 6,667,245, a MEMS switch is made from tungsten. Two vias have contact regions that touch in the closed switch state. To expose the contact surfaces, a metallic sacrificial layer between the vias is removed.

Micromechanical RF MEMS switches are described in “Simplified RF MEMS Switches Using Implanted Conductors and Thermal Oxide,” Siegel et al, Proceedings of the 36th European Microwave Conference, September 2006, conference volume pp. 1735-1739, and in “Low-complexity RF MEMS technology for microwave phase shifting applications,” Siegel et al, German Microwave Conference, Ulm, Germany, April 2005, conference volume pp. 13-16. With this technology, all components in a transmit-receive module, such as RF phase shifters, RF filters and RF MEMS switches, can be produced on one and the same substrate.

DE 10 2004 010 150 A1, which corresponds to U.S. Publication No. 2007/0215446, presents a high-frequency MEMS switch. In producing the MEMS switch, electrically conductive layers are first formed as signal lines and an electrode arrangement on a substrate made of a semiconductor material, and the switch element is subsequently fastened to the substrate surface in a cantilevered manner. To create a bending and the restoring force in the bending region of the switch element, its surface is fused by laser heating in order to produce the necessary mechanical tensile stress in the elastic bending region. However, it is also possible to use a bimorphic material in order to induce the curvature. In place of a bottom electrode, a high-resistance substrate can also be used to produce an electrostatic force, with metallization being provided with the back of said substrate. Other embodiments of high-frequency MEMS switches are presented in DE 10 2004 062 992 A1, for example.

### SUMMARY OF THE INVENTION

It is therefore an object of the present invention to provide an arrangement that has a circuit and a MEMS circuit element and that increases an integration density as much as possible.

Accordingly, an integrated arrangement having a circuit and a MEMS (MEMS=Micro-Electro-Mechanical System) is provided. The circuit has a plurality of semiconductor components that are produced in a semiconductor region. The components are preferably produced in a standard process for manufacturing MOSFETs and/or bipolar transistors. The semiconductor components are connected to one another by metallic traces in multiple metallization levels located one over the other to produce the circuit. The metallic traces are made of aluminum, for example. Traces in different metallization levels are electrically connected to one another by vias. In addition, multiple components are advantageously wired into a drive circuit to drive the MEMS switch element.

The metallization levels are formed between the MEMS switch element and the semiconductor components, so that the MEMS switch element is located above the topmost metallization level.

The MEMS switch element is designed to be movable. For example, a movable area of the MEMS switch element can have the shape of an overhanging arm that has only one support. Such a form of overhanging arm can also be described as a cantilever. This arm is stressed in shear, torsion, or in particular in bending, when motion takes place. To this end, the support is, for example, an enclosure within dielectric layers in which all six degrees of freedom are fixed. For an appropriate motion, the movable cantilevered microstructure is preferably designed to be elastic, at least in sections. The embodiment of the microstructure is thus cantilevered when it does not adjoin other solid material, at least in some areas. The cantilevered microstructure is preferably rigidly enclosed in material of the arrangement, at least on one side. Alternatively or in combination, other supports (fixed support/movable bearing) can also be provided. As an alternative to a cantilever, the MEMS switch element can also be structured as a beam, bridge or membrane. Free space for motion of the MEMS switch element is required above the MEMS switch element.

The movable MEMS switch element, an electrode arranged with respect to the MEMS switch element, and a dielectric acting between the MEMS switch element and the electrode produce a variable impedance for a high-frequency signal. In this context, a high-frequency signal is to be understood as a signal with a frequency greater than one gigahertz. In this regard, two different switch positions of the MEMS switch element produce two impedances that are different from one another and affect the high-frequency signal differently.

In addition, a drive electrode for producing an electrostatic force to move the MEMS switch element is constructed in the topmost metallization level. The drive electrode is preferable insulated from the electrode for the variable impedance by a dielectric. The drive electrode is preferably connected to the circuit. The circuit is preferably designed to control the electrostatic force. A voltage between the drive electrode and the MEMS switch element preferably accomplishes a bending of the movable MEMS switch element, wherein the bending accomplishes a motion into a switch position in which a movable part of the MEMS switch element is brought close to the dielectric. The drive electrode is advantageously constructed inside the topmost metallization level and connected in an electrically conductive manner to other traces, to ground, or to components.

In an embodiment, the geometric design of the MEMS switch element and of the electrode separated from the MEMS switch element by the dielectric influences an effective dielectric constant ε_{r,eff}, which is variable as a function of the switch position of the MEMS switch element. By this means, the high-frequency signal can be influenced, and a switchable filter or a switchable antenna can be implemented to advantage.

To implement a switchable filter the MEMS switch element is designed as a strip, for example, whose length, together with the effective dielectric constant and the distance from the electrode, is tuned to a resonant frequency or resonant frequency range. At least one end of the MEMS switch element is designed to be movable, so that, in a raised switch position, the effective dielectric constant is reduced and the resonant frequency is increased. In an analogous embodiment, a switchable antenna with a variable resonant frequency or resonant frequency range can be implemented in a corresponding manner with a MEMS switch element.

According to another embodiment, the MEMS switch element is designed as a phase shifter. Here, the MEMS switch element forms part of a signal path for the high-frequency signal. The phase swing is again dependent on the effective dielectric constant. The movable part of the MEMS switch element functioning as a signal conductor is, for example, a movable edge positioned relative to the electrode, wherein the MEMS switch element produces a lower effective dielectric constant in the raised position, so that the phase swing is reduced as compared to a lowered position.

In another embodiment, a switch is provided for the high-frequency signal, wherein the variable impedance changes the attenuation. An electrode positioned with respect to the MEMS switch element is formed by a trace in the topmost metallization level. In this context, the lowest metallization level is produced above the semiconductor components, while the topmost metallization level is produced below the MEMS switch element. The electrode is advantageously produced so as to be insulated within the topmost metallization level. Alternatively, the electrode can also be connected in an electrically conductive manner to other traces, to ground, or to components.

The electrode is preferably produced as a planar capacitor electrode. A dielectric, preferably thin, is located between the electrode and the MEMS switch element. To produce the impedance, the electrodes, the dielectric and the MEMS switch element form a capacitor, wherein the spacing between the movable MEMS switch element and the electrode can be changed in the manner of a parallel-plate capacitor in order to change the impedance. To this end, the MEMS switch element has a conductive area, or the MEMS switch element is completely made of a conductive material.

In this variant further development, both a series switch and a parallel switch can be implemented by the MEMS switch element as a switch.

In the case of series switch, provision is preferably made that a signal path for the high-frequency signal passes through a first metal trace in the topmost metallization level, through the MEMS switch element by way of the dielectric and the electrode, and also through a second metal trace in the topmost metallization level. In a closed (lowered) switch position, the signal path through the MEMS switch element has a lower impedance for the high-frequency signal than in an opened (raised) switch position.

In a parallel switch, in contrast, the signal path is continuous. In one switch position for a low impedance, the MEMS switch element produces a short circuit of the high-frequency signal to ground. To this end, the signal path is capacitively coupled or conductively connected to the electrode, for example, and the MEMS switch element is capacitively coupled or connected to ground. Alternatively, the MEMS switch element is part of the signal path or is capacitively coupled or connected to the signal path, and the electrode is capacitively coupled or connected to ground. The ground connection takes place through the outer metal surfaces of a coplanar line, for example.

It is possible that, outside the area of the MEMS switch element, material substantially identical to the MEMS switch element is structured as additional traces, for example for a supply line.

According to a further embodiment, provision is made that the MEMS switch element has a metal, wherein the metal of the MEMS switch element has a lower coefficient of thermal expansion than the metal of the metallization levels.

In another further embodiment, which can also be combined, provision is made that a metal of the MEMS switch element has a higher melting point than the metal of the metallization levels. For example, the metal of the metallization levels is aluminum, but in contrast, the MEMS switch element preferably has tungsten. According to an advantageous further development, the MEMS switch element has an alloy of at least two different metals—for example a titanium-tungsten alloy—in an area facing the electrode. Another embodiment provides that at least one surface of a movable area of the MEMS switch element is insulated by a dielectric.

According to an embodiment, the MEMS switch element has a plurality of metals—hence at least two metals. The metals are different and adhere to one another and/or form an alloy. In this regard, the metals are preferably arranged in multiple layers, so that the MEMS switch element is designed as a multilayer system.

The circuit can be designed to process a high-frequency signal and is connected to the MEMS switch element for switching the high-frequency signal. This makes it possible to integrate all functions of a high-frequency application on a single chip.

According to a further embodiment, the MEMS switch element is designed to switch and/or influence the high-frequency signal. For switching of the high-frequency signal, the change in the impedance produces a significant attenuation of the signal. For influencing the high-frequency signal, the MEMS switch element can act as a phase shifter, for example, wherein the phase angle is changed or a phase offset is produced.

While it is possible to produce the integrated arrangement with a microstripline in operative relationship with a back side metallization, the integrated arrangement in a preferred further development, in contrast, has a coplanar line with the MEMS switch element as a part of the coplanar line. In a coplanar line, two ground lines are arranged parallel to the signal line. In this context, the two ground lines can be made of the metal of the MEMS switch element or from a trace in an available metallization level—in particular the topmost metallization level. Preferably, both ground lines are conductively connected together by a bridge formed in the topmost metallization level.

In order to accomplish shielding of the signal path of the coplanar line, it is possible to metallize the back side of the chip and connect the back side metallization to ground, for example.

A direction of motion of the movable MEMS switch element is preferably outside the plane of the chip surface, in particular perpendicular to the plane of the chip surface.

In an embodiment, the movable MEMS switch element has an intrinsic mechanical stress. The intrinsic mechanical stress accomplishes a motion of the movable MEMS switch element into a switching position through its deformation. In this opened switch position, a high impedance gives rise to a significant attenuation of the HF signal. For example, a deformation of the MEMS switch element in the opened position remains essentially unchanged during manufacture and operation or under external influences—such as elevated temperature or mechanical loading—as a result of the properties of the material used for the movable MEMS switch element.

According to an embodiment, provision is made that the MEMS switch element can be deflected at least in the vertical direction (thus perpendicular to the chip surface). Provision is preferably made in this regard that the MEMS switch element can be deflected vertically into at least one opening or cavity. Advantageously, the opening or cavity is hermetically sealed by a cover layer. An advantageous embodiment of the variant further development provides that the vertical deflection is limited by the cover layer—which is, for example, composed of a bonded cover wafer to hermetically seal the opening. For example, an additional electrode for controlling the motion of the MEMS switch element is formed in the cover layer.

In an embodiment, the MEMS switch element has multiple layers. The layers here are preferably arranged essentially parallel to the chip surface in the closed switch position of the MEMS switch element. The future mechanical properties—such as the intrinsic mechanical stress—have preferably already been set during the production of the layers. According to another advantageous embodiment, the MEMS switch element has a structure with multiple holes and/or striplike segments.

In yet another embodiment, provision is made that multiple signal paths can be switched simultaneously or in time sequence by the MEMS switch element.

Another aspect of the invention is the use of an above-described integrated arrangement in a high-frequency application, in particular in the fields of communications or radar.

The invention additionally has the object of specifying a method for producing an integrated arrangement with a circuit and a MEMS switch element.

Accordingly, a method for producing an integrated arrangement is provided. First, a plurality of semiconductor components are produced in a semiconductor area. The semiconductor components are connected to one another and to other components, terminals, or the like, by traces. To this end, the traces are structured in multiple metallization levels located one over the other, for example by means of masks and etching steps.

A MEMS switch element is formed over the metallization levels by first depositing a dielectric and a sacrificial layer on the traces. Metal for the MEMS switch element is deposited over the dielectric and sacrificial layer, and is structured by masks and etching steps, for example.

In a later process step, the sacrificial layer is removed, for example by etching. The removal of the sacrificial layer exposes a cantilevered area of the MEMS switch element. The sacrificial layer can have polycrystalline silicon, amorphous silicon, metal or silicide, for example. Preferably, the material of the sacrificial layer is selectively etched with respect to the material of the MEMS switch element.

A trace is structured in the topmost metallization level as an electrode in order to produce a variable impedance together with the dielectric and the MEMS switch element.

According to an embodiment, the underside of the movable MEMS switch element is formed by alloying the material of the sacrificial layer, which is to be removed later in the process, with the material of a movable area of the MEMS switch element that is located above the sacrificial layer. The mechanical properties of the MEMS switch element are preferably set by means of the alloying.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawings which are given by way of illustration only, and thus, are not limitive of the present invention, and wherein the sole FIGURE shows a schematic cross-section through an integrated arrangement at one point during manufacture. In this regard, the representation is not to scale either overall or with regard to the dimensions of the elements shown.

### DETAILED DESCRIPTION

A part of an integrated arrangement is visible in the cross-section shown schematically in the FIGURE. At the bottom, a semiconductor material 1, for example including silicon, gallium arsenide or silicon-germanium, or of a combination of various semiconductors, is provided. A plurality of semiconductor components are integrated in this semiconductor material 1. For better clarity, only one active component 400 is illustrated in the FIGURE. This component is a MOS field-effect transistor 400 with a gate electrode 401, a gate oxide 402, a source semiconductor region 403, and a drain semiconductor region 404. Additionally, a high-value resistor 10 made of polycrystalline silicon is shown in the FIGURE as a component.

The plurality of components (400, 10) are connected to one another by traces 101 ff, 201 ff, 301 ff, made of aluminum. Traces also permit connections to terminals of the arrangement. The components (400, 10) together with the traces 101 ff, 201 ff, 301 ff, form a circuit of the arrangement, which has multiple functions, as for example amplifying high-frequency signals. The traces 101 ff, 201 ff, 301 ff are made of aluminum and are located in three metallization levels 100, 200, 300, which are insulated from one another by a layer of dielectric 23, 24, in each case. Connections between the metallization levels are by means of vias 50.

Built above the metallization levels 100, 200, 300 is a MEMS switch element 500 (MEMS—Micro-Electro-Mechanical System). The FIGURE shows a state in the production process in which the MEMS switch element 500 within a passivation layer 27 has been exposed by the etching of an opening.

In preceding process steps, the components 400, 10 and the metallization levels were produced. Next, a sacrificial layer 511 of aluminum was deposited on a topmost structured dielectric layer 26. Next, tungsten was deposited and structured on the sacrificial layer 511 and on the dielectric layer 26 to form the MEMS switch element 500. Along with the structuring, a gap 512 is also etched out within the structured tungsten, thus exposing the sacrificial layer 511. Next, an etch stop layer 28, made of silicon nitride for example, a passivation layer 26 of BPSG (borophosphosilicate glass), and a mask 29 for structuring the opening, are in turn deposited and structured. This process state is shown schematically in the FIGURE.

It is also possible (though not shown in the FIGURE) to produce an alloy of the material of the sacrificial layer 511 and the MEMS switch element 500, which then becomes a part of the MEMS switch element as a thin layer (not shown). To implement an elastically curved and movable structure of the MEMS switch element that has a compressive stress on the underside, an intentional alloy between the material of the sacrificial layer and the material of the movable area of the MEMS switch element is created by a high-temperature step. Preferred material combinations for this purpose are tungsten and aluminum, wherein the phase WAl₄ is stable to 1320° C. and has a larger lattice constant than pure tungsten.

The use of tungsten or the alloy of tungsten and aluminum can offer the advantage that the MEMS switch element has better temperature stability during manufacture, storage, and operation. In this regard, flow behavior at high temperatures is reduced. In this way, the mechanical properties are improved, resulting in a constant switching voltage and reduced drift effects.

The use of a mechanically stiff material for the MEMS switch element reduces the probability of sticking effects during production, operation or storage. Moreover, the mechanical stiffness of the movable MEMS switch element can reduce the probability of unintended closing or opening of the switch, e.g. due to relatively large signal amplitudes or mechanical acceleration. A necessary shape stability over a wide temperature range, both over a large number of switch cycles during operation and during manufacture, can be achieved through the use of a material that is resistant to high temperatures.

In a subsequent process step, the sacrificial layer 511 is removed selectively with regard to the other materials of the exposed surfaces (26, 27, 28, 520, 500) by etching. After etching of the sacrificial layer 511, the MEMS switch element 500 has a cantilevered area 510 and an area 505 that is enclosed between the passivation 27 with the etch stop layer 28 and the topmost metallization level 300. As a result of an intrinsic mechanical stress, the cantilevered area 510 of the MEMS switch element 500 moves in the direction of displacement d into an opened switch position (not shown).

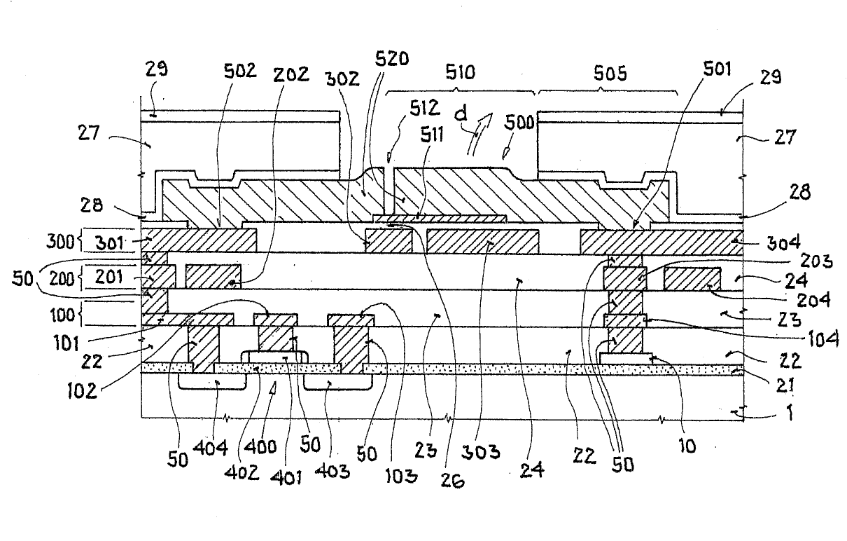

In a closed switch position (shown in the FIG. 1f the sacrificial layer 511 is considered to be absent), a high-frequency signal comes from a first low-resistance signal line 304 in the topmost metallization level 300, through the connecting contact 501, into the movable MEMS switch element 500, from there into the area 520, and onward into the second low-resistance signal line 301 in the topmost metallization level. The use of traces 301, 304 in the topmost metallization level 300 can have the advantage that these traces 301, 304 are made relatively thick, and the HF losses in these traces 301, 304 are relatively low. In the closed switch position, the capacitive coupling between the MEMS switch element 500 and the area 520 does not take place primarily through the gap 512, but instead through a dielectric 26, which is thin as compared to the gap 512, to an electrode 302 made of aluminum in the topmost metallization level 300. Here, the MEMS switch element 500, the dielectric 26 and the electrode 302 form a type of parallel-plate capacitor having the thickness of the dielectric 26. An additional capacitive coupling is produced between the electrode 302 and the area 520. This can be advantageous for symmetries in the HF layout. Alternatively, a direct electrically conductive connection between the electrode 302 and the low-resistance signal line 301 is possible.

In contrast, in the opened position, the MEMS switch element 500 is removed from the electrode 302. The capacitive coupling between the MEMS switch element 500 and the electrode 302 is significantly reduced, so that the change in impedance resulting therefrom permits a considerable attenuation of the HF signal.

To move the MEMS switch element 500 from the opened switch position to the closed switch position, an electrostatic force is controlled that opposes the intrinsic mechanical stresses of the MEMS switch element 500. To this end, a drive electrode 303 is provided, wherein a DC voltage can be applied to the drive electrode 303 and the MEMS switch element 500 in such a manner that the electrostatic force is greater than the intrinsic mechanical stresses that are acting. To apply the DC voltage to the MEMS switch element 500, the MEMS switch element 500 is connected to the high-value resistor 10 made of polycrystalline silicon. This high-value resistor 10 reduces any possible coupling-out of the HF signal.

If the MEMS switch element 500 and the drive electrode 303 are viewed in rough approximation as a two-plate capacitor, the force acting on the MEMS switch element 500 is inversely proportional to the square of the distance between the MEMS switch element 500 and the drive electrode 303. The design of the drive electrode 303 in the topmost metallization level 300—which is to say the metallization level below the MEMS switch element—thus permits an extremely small distance between the MEMS switch element 500 and the drive electrode 303. Consequently, very much lower switching voltages can be used than is the case for a drive electrode that is separated further (not shown). Accordingly, the dielectric layer 26 need only be adapted to this lower voltage in terms of its quality and thickness. Furthermore, the drive circuit can be implemented directly through the components, so that no additional separate special components for higher voltages need be used.

The production of the MEMS switch element preferably takes place following the production of the components, advantageously in a separate module of what is known as a back-end process (BEOL—Back End Of Line), so that the components advantageously cannot be changed by the production of the MEMS switch element. HF shielding structures such as ground lines or ground planes can also be integrated with the MEMS switch element and/or the HF circuit. It is also possible to embody the MEMS switch element as an independent module, wherein the circuit can be produced independently from this module. Thus, it is possible to produce circuits both with and without MEMS switch elements at the same time. The production of the MEMS switch element has no noticeable effect on the electrical parameters of the components of the circuit, since no high-temperature process is strictly necessary for producing the MEMS switch element. Consequently, the circuit and the MEMS switch element can be changed independently of one another.

In this regard, the invention is not limited to the design of the MEMS switch element as a simple bending beam, as is shown in the FIGURE. A variety of different geometries can be used. Another possible geometry of a MEMS switch element is shown in FIG. 1 of DE 10 2004 010 150 A1, for example.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An integrated arrangement comprising:
a circuit having a plurality of semiconductor components that are connected to one another by metallic traces in multiple metallization levels located one over the other to produce the circuit;
a MEMS switch element, the MEMS switch element being movable; and
a drive electrode positioned with respect to the MEMS switch element, for producing an electrostatic force to move the MEMS switch element,
wherein the metallization levels are formed between the MEMS switch element and the semiconductor components so that the MEMS switch element is located above the topmost metallization level,
wherein the MEMS switch element is positioned with respect to a dielectric, so that the movable MEMS switch element and the dielectric produce a variable impedance for a high-frequency signal, and
wherein the drive electrode is provided in the topmost metallization level.

2. The integrated arrangement according to claim 1, wherein an electrode positioned with respect to the MEMS switch element is formed by a trace in the topmost metallization level, and wherein the dielectric is provided between the electrode and the MEMS switch element so that the movable MEMS switch element, the dielectric, and the electrode produce the variable impedance.

3. The integrated arrangement according to claim 1, wherein the MEMS switch element has a metal, wherein the metal of the MEMS switch element has a lower coefficient of thermal expansion than the metal of the metallization levels.

4. The integrated arrangement according to claim 1, wherein the MEMS switch element has a metal, wherein the metal of the MEMS switch element has a higher melting point than the metal of the metallization levels.

5. The integrated arrangement according to claim 1, wherein the MEMS switch element has a plurality of metals, wherein the metals are different, and wherein the metals adhere to one another and/or form an alloy.

6. The integrated arrangement according to claim 1, wherein the circuit is designed to process a high-frequency signal and is connected to the MEMS switch element.

7. The integrated arrangement according to claim 1, wherein the MEMS switch element is designed to switch and/or influence the high-frequency signal.

8. The integrated arrangement according to claim 1, further comprising a coplanar line, wherein the MEMS switch element is embodied as a part of the coplanar line.

9. The integrated arrangement according to claim 1, wherein the drive electrode is connected to the circuit, and wherein the circuit is designed to control the electrostatic force.

10. The integrated arrangement according to one of the preceding claims, wherein a direction of motion of the movable MEMS switch element is outside the plane of the chip surface or substantially perpendicular to the plane of the chip surface.

11. The integrated arrangement according to claim 1, wherein the movable MEMS switch element has an intrinsic mechanical stress, wherein the intrinsic mechanical stress accomplishes a motion of the movable MEMS switch element into a switching position through its deformation.

12. The integrated arrangement according to claim 1, wherein the integrated arrangement is provided in a high-frequency application for communication or radar.

13. A method for producing an integrated arrangement, the method comprising:
producing a plurality of semiconductor components in a semiconductor area;
connecting the semiconductor components via traces, the traces being structured in several metallization levels located one over the other above the semiconductor components;
providing a MEMS switch element above the metallization levels such that a dielectric and a sacrificial layer are deposited on the traces, metal for the MEMS switch element is deposited over the dielectric and sacrificial layer and is structured, and the sacrificial layer is removed; and
structuring, in the topmost metallization level, a trace as a drive electrode and/or as an electrode, the electrode forming a variable impedance together with the dielectric and the MEMS switch element.
